(19) United States
(12) Patent Application Publication
(10) Pub. No.: US 2024/0095480 A1
(43) Pub. Date: Mar. 21, 2024

(54) PRINT MEDIA CALIBRATION

(71) Applicant: HEWLETT-PACKARD DEVELOPMENT COMPANY, L.P., Spring, TX (US)

(72) Inventors: Pooshpanjan ROY BISWAS, Sant Cugat del Valles (ES); Juan SAEZ GOMEZ, Sant Cugat del Valles (ES); Alessandro BELTRAMI

(21) Appl. No.: 17/768,816

(22) PCT Filed: Jan. 30, 2020
(86) PCT No.: PCT/US2020/015890

§ 371 Date: Apr. 13, 2022

(51) Int. Cl. G06K 15/02; H04N 1/60

(52) U.S. Cl. CPC G06K 15/027; H04N 1/605; G06K 2215/101

(57) ABSTRACT

In an example, a method includes receiving, at a printing apparatus, a print target. The method may also include printing a drop linearization chart on a sample of the print target and measuring the drop linearization chart to determine a measured drop linearization curve for the print target. The method may include comparing the measured drop linearization curve to a plurality of predefined drop linearization curves to determine a most similar drop linearization curve from the plurality of predefined drop linearization curves, and applying a linearization defined by the most similar drop linearization curve to print data to be printed on the print target.

### BACKGROUND

Color performance in printing can be affected by the type of media being printed on. For example, print agents may interact differently with different types of media, spreading of drops of print agent may occur to a lesser or greater extent and colors may therefore appear different (e.g. lighter or darker) when printed on different types of print media. Different colored print agents may also be affected to different extents by different types of media which can lead to inaccuracies in colors produced by a halftone combination of two or more process color print agents.

### BRIEF DESCRIPTION OF THE DRAWINGS

Non-limiting examples will now be described with reference to the accompanying drawings, in which:

FIG. 1 shows a schematic representation of an example method, which may be a method for calibrating a printing apparatus for printing on a new type of print target;

FIG. 2 shows a schematic representation of another example method, which may be a method for calibrating a printing apparatus for printing on a new type of print target;

FIG. 3 shows a schematic representation of an example printing apparatus; and

FIG. 4 shows a schematic representation of an example machine-readable medium in association with a processor.

### DETAILED DESCRIPTION

Different types of media may behave differently in terms of the photometric response to the number of drops of print agent (e.g. colored ink) applied to the media. In particular, applying print agent with a particular drop size may produce a different measureable photometric response on different media types, for example due to different drop spreading behaviour on different media caused by properties of a particular media (e.g. porosity). Therefore in order to achieve a more consistent color performance across different media, a linearization calibration may be applied based on a print media type.

However, when a user wishes to print on a particular media, they may not know what linearization calibration to apply for that particular media, particularly when printing on a new type of media. If a user manually selects a media type from a list of different media types prior to printing, this may not produce an optimal color response as a media may be labelled as a particular type but in fact may have a color response that is closer to a different type of media. Furthermore, performing a full color response analysis for each new type of media that is used with a printing apparatus may be overly time consuming or may not be possible, with sufficient accuracy, with the resources available to a user of the printing apparatus. The examples described herein may enable an automatic selection and application of a color calibration by a printing apparatus without requiring user input.

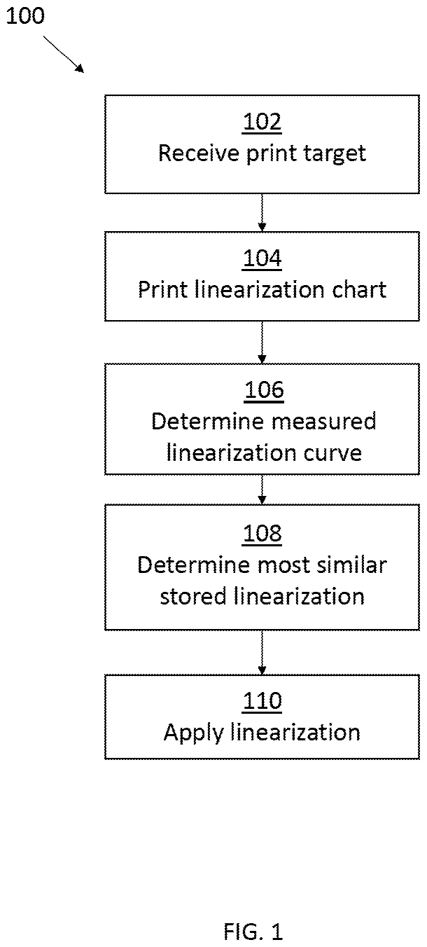

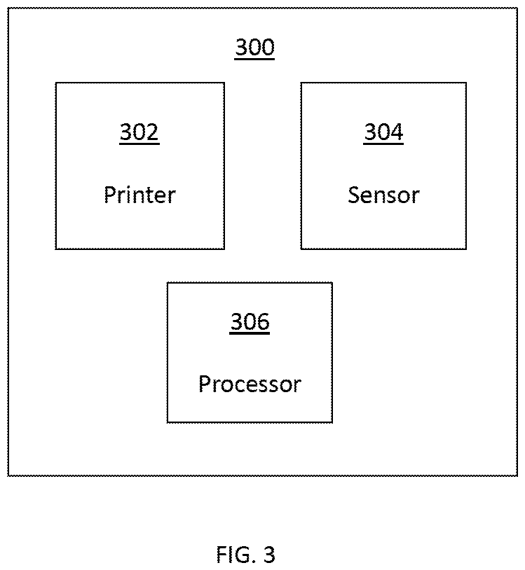

FIG. 1 shows a flowchart for a method 100, which may be a method for calibrating a printing apparatus for printing on a new type of print target. Block 102 of the method 100 comprises receiving, at a printing apparatus, a print target, i.e. a media to be printed on, which may be, for example, paper, self-adhesive vinyl, a PVC banner, a layer of build material for 3-D printing, or any suitable kind of print target. The printing apparatus may be, for example a printing apparatus as described below with reference to FIG. 3.

Block 104 of method 100 comprises printing a drop linearization chart on a sample of the print target. The printing apparatus may print using a set of process color print agents (or process color color inks) such as cyan, magenta yellow and key (CMYK) or another set of process color print agents. Each of the process color print agents may interact differently with a particular print target and may therefore have different linearization responses. In some examples, therefore, printing the linearization chart may comprise printing a linearization pattern for each of a plurality of process color print agents of the printing apparatus. Determining a measured drop linearization curve may comprise determining a drop linearization curve for each process color print agent to provide a set of measured drop linearization curves for the print target. Each linearization pattern may comprise a halftoned linearization plot comprising a plurality of test areas each printed with a different number of drops of print agent. In some examples, printing the linearization chart may comprise printing a halftoned linearization plot having a range of 0 to 3 drops per halftone cell increasing in increments of 0.1 drops to provide 31 different test areas for each process color print agent each printed with an incremental number of drops for each image data point, starting from 0 to 3 drops.

Block 106 of method 100 comprises measuring the drop linearization chart to determine a measured drop linearization curve for the print target. In some examples, block 106 comprises measuring a photometric response of each test area of the printed linearization chart, for example using a spectrophotometer, which may be integral with the printing apparatus. In some examples the process color print agents may be CMYK inks and measuring the photometric response may comprise measuring a CIE L* parameter for CMK inks and measuring a CIE b* parameter for Y ink to determine the photometric response of each test area. The photometric response could also be characterized using other suitable parameters as defined in other typed of color spaces such as HSL, RGB etc. A measured linearization curve can then be determined for each of the process color print agents based on the measured photometric response of each of the test areas as a function of number of drops.

Block 108 of method 100 comprises comparing the measured drop linearization curve to a plurality of predefined linearization curves. The predefined linearization curves may be stored (for example by the printing apparatus, or in a virtual storage location accessible by the printing apparatus) ready for comparison, or may be derived from a plurality of stored linearization tables. In some examples, stored linearization tables may be provided by producing measured and processed linearization curves for a plurality of different materials (e.g. using the method described above in relation to block 106). The linearization tables define corrections to be applied to a particular print job to correct for a particular linearization response or linearization curve (which may be associated with a particular media type). The predefined linearization curve for comparison with a measured linearization curve can therefore be derived from a previously stored predefined linearization table. A linearization table for a plurality of different media types may be stored along with other related color resource information for that media, like color maps, which may be used to convert an image (e.g. CMYK which has 4 color channels) into n-channels where n is the number of printer ink channels for a particular printer.

In some examples, the predefined linearization curves may be provided by modelling the properties of different types of media or may be extracted from previously produced linearization tables. The predefined linearization curves may therefore provide a stored library of media types and their expected photometric responses as a function of drop size. In some examples, the library may comprise a library of linearization tables, defining a correction to apply for a particular linearization curve, from which the predefined linearization curve can then be derived. The stored linearization curves/linearization tables may be stored in the printing apparatus itself or the printing apparatus may have access to the stored linearization curves on a cloud.

Determining a most similar drop linearization curve from the plurality of predefined linearization curves may comprise calculating a root mean square (RMS) difference between the measured drop linearization curve and each predefined linearization curve. The predefined linearization curve which has the smallest RMS difference from the measured linearization curve may then be selected as being the most similar drop linearization curve, having the best fit for the print target. In some examples, other suitable comparison techniques may be used to determine which predefined linearization curve is closest to the measured linearization curve of the print target, for example, curves can be compared in terms of absolute difference, RMSE, goodness of fit coefficient (GFC) etc.

In some examples, where the printing apparatus uses a plurality of process color print agents for printing and the printed linearization chart comprises a printed linearization pattern for each process color print agent, the predefined linearization curves may be stored as sets of linearization curves, or derived from stored sets of linearization tables. Each set may comprise a separate linearization curve for each process color print agent. In this case, comparing the measured drop linearization curve to a plurality of predefined linearization curves comprises comparing the set of measured drop linearization curves with a plurality of predefined sets of drop linearization curves and determining a RMS difference for each process color print agent. Determining a most similar drop linearization curve may then comprise selecting a predefined set of drop linearization curves having a lowest average RMS difference, averaged over the process color print agents.

Block 110 of method 100 comprises applying a linearization defined by the most similar drop linearization curve to print data to be printed on the print target. Block 110 may also comprise applying other color calibrations to the print data based on color calibration information associated with the most similar drop linearization curve, for example, such as color maps. The print data is modified such that the number of drops deposited during printing is corrected to provide an improved color response. In some examples, the method 100 may further include printing on the received print target using the applied linearization settings.

Therefore, the method 100 of FIG. 1 enables a new media to be printed with improved color performance, as a color calibration can be tailored to different types of print targets, including new types of print targets. The method can also improve efficiency of print agent use as an applied number of drops may be able to be reduced whilst still producing a certain strength of color, based on the applied linearization. This may significantly improve print agent efficiency for certain print targets when used with certain types of process color print agents. In addition, the color gamut volume available for certain types of media may be increased. Furthermore, the method enables linearized color responses to be achieved without using ICC profiles. That is, the whole calibration can be performed by the printing apparatus itself, and does not involve a user of the apparatus having specialised knowledge of different media types. Performing the linearization in drop space also enables the calibration to be selected and applied by the printing apparatus as part of the printing process so that printer specific linearization corrections are also effectively taken into account with the correction.

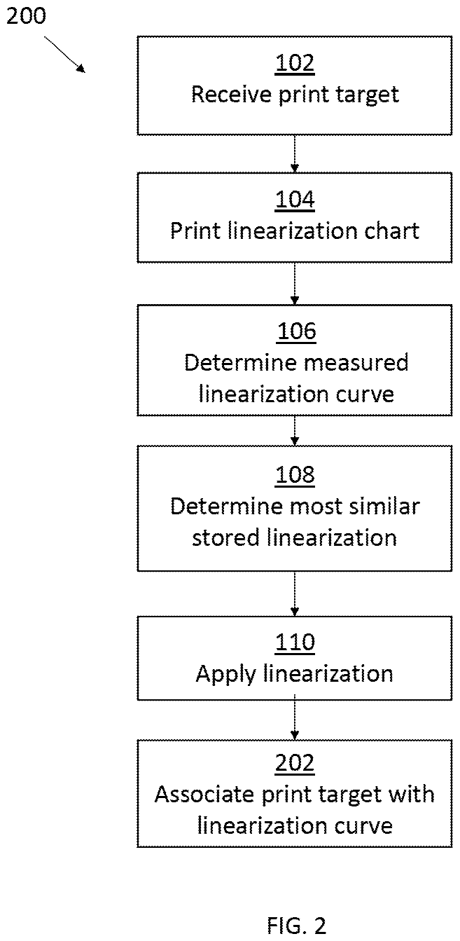

FIG. 2 shows another method 200 for calibrating a printing apparatus for printing on a new type of print target. The method 200 comprises blocks 102 to 110 as described above in relation to FIG. 1. The method 200 also includes block 202, which comprises associating the determined most similar linearization curve with the type of print target and storing the association for subsequent printing on the same type of print target. In this way, once a linearization measurement has been performed for a particular new type of print target, subsequent printing on the same type of print target can include automatically selecting the associated most similar linearization curve, and any other associated color resources, without needing to print and measure another linearization chart.

FIG. 3 shows a simplified representation of a printing apparatus 300, which may be to perform the method of FIG. 1 or FIG. 2. The printing apparatus 300 comprises a printer 302, which may be, for example, an inkjet printer, 3D printer, or another type of printer. The printer 302 is to receive a new print media and print a linearization chart on a sample of the print media, for example on a sample page of a new print media.

The printing apparatus 300 further comprises a sensor 304 to measure the printed linearization chart. In some examples, the sensor comprises an inline spectrophotometer, located along a media print path of the printing apparatus to measure a photometric response of the printed linearization chart.

The printing apparatus 300 also includes a processor 306 to calculate a linearization curve for the new print media from data measured by the sensor, e.g. photometric data. The processor 306 is to compare the calculated linearization curve with a plurality of predefined linearization curves and select a closest linearization curve from the predefined linearization curves based on the comparison. The printer 302 is then to print on the print media using a calibration associated with the closest linearization curve. The calibration may comprise, for example applying a color map conversion and/or applying a linearization correction to a print data file, or to print instructions representing a job to be printed.

In the example printing apparatus 300, the printer 302, sensor 304 and processor 306 are all formed integrally with the printing apparatus 300 and the calibration can therefore be performed as part of the printing process in a closed loop system.

In some examples, the processor 306 is to compare the calculated linearization curve with each of the predefined linearization curves by calculating an RMS difference between the calculated curve and each predefined curve.

In some examples, the printer 302 is to print using a set of process color print agents, and the linearization chart comprises a linearization plot for each process color print agent. The processor 306 may then calculate a linearization curve for each process color print agent and compare each of the calculated linearization curves with a plurality of predefined linearization curves. The comparison may then comprise determining an average RMS difference for the set of process color print agents.

The processor 306 may be to receive an input selecting a print media type having particular mechanical properties and to apply settings within the printer based on the mechanical properties of the selected print media type. Thus, in some examples, a user may select a print media type when inputting a new print media to the printing apparatus 300, which may be used to select different settings inside the printer based on mechanical properties of the media (e.g. thickness, width etc.). In these examples, color properties are selected separately based on the automatic linearization described herein. In this way, both color and mechanical properties may be taken into account when adapting a printing apparatus to print on a new media. By treating mechanical properties and color properties independently from each other, this means that best fit color resources can be applied regardless of whether the mechanical properties of the media match up with the mechanical properties of a media type associated with a particular stored linearization and color map.

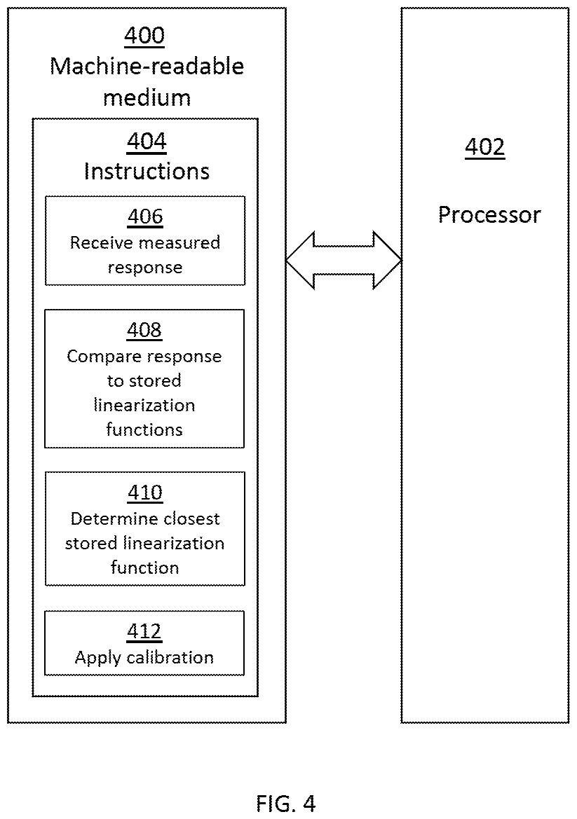

FIG. 4 shows a tangible machine-readable medium 400 in association with a processor 402. The tangible machine-readable medium 400 may form part of the printing apparatus 300 of FIG. 3. In some examples, the machine-readable medium may comprise instructions to perform the method of FIG. 1 or 2.

In the example shown in FIG. 4, the machine-readable medium 400 comprises a set of instructions 404 which, when executed by the processor 402, cause the processor 402 to, at block 406, receive a measured linearization response from a print media for each of a set of process colors. At block 408, the instructions 404 are to compare the measured linearization response to each of a plurality of predefined linearization functions by calculating a root mean square difference between each measured linearization response and each predefined linearization function. At block 410, the instructions 404 are to determine a closest linearization function as being a set of predefined linearization functions having a lowest root mean square difference averaged over the set of process colors. At block 412 the instructions 412 are to apply a linearization calibration based on the closest linearization function to an image to be printed on the print media.

In some examples, the measured linearization response comprises a measured photometric response as a function of number of drops applied to the print media, which may be measured by a sensor, e.g. a spectrophotometer.

In some examples, the machine-readable medium 400 may comprise further instructions to associate the applied linearization calibration with the print media and store the applied linearization for application to print media of the same type during subsequent printing operations.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. A method comprising:
receiving, at a printing apparatus, a print target;
printing a drop linearization chart on a sample of the print target;
measuring the drop linearization chart to determine a measured drop linearization curve for the print target;
comparing the measured drop linearization curve to a plurality of predefined drop linearization curves to determine a most similar drop linearization curve from the plurality of predefined drop linearization curves; and
applying a linearization defined by the most similar drop linearization curve to print data to be printed on the print target.

2. A method according to claim 1, wherein comparing the measured drop linearization curve to a plurality of predefined linearization curves comprises calculating a root mean square (RMS) difference between the measured drop linearization curve and each predefined linearization curve; and wherein determining a most similar drop linearization curve comprises selecting a predefined linearization curve having a lowest calculated RMS difference.

3. A method according to claim 1, wherein printing the drop linearization chart comprises printing a linearization pattern for each of a plurality of process color print agents of the printing apparatus and wherein determining a measured drop linearization curve comprises determining a drop linearization curve for each process color print agent to provide a set of measured drop linearization curves for the print target.

4. A method according to claim 3, wherein each linearization pattern comprises a halftoned linearization plot comprising a plurality of test areas each printed with a different number of drops of print agent.

5. A method according to claim 3, wherein comparing the measured drop linearization curve to a plurality of predefined linearization curves comprises comparing the set of measured drop linearization curves with a plurality of predefined sets of drop linearization curves and determining a RMS difference for each process color print agent.

6. A method according to claim 5, wherein determining a most similar drop linearization curve comprises selecting a predefined set of drop linearization curves having a lowest average RMS difference, averaged over the process color print agents.

7. A method according to claim 1, further comprising associating the determined most similar linearization curve with the type of print target and storing the association for subsequent printing on the same type of print target.

8. A printing apparatus comprising:
a printer, to receive a new print media, wherein the printer is to print a linearization chart on a sample of the print media;
a sensor to measure the printed linearization chart;
a processor to calculate a linearization curve for the new print media from data measured by the sensor;
wherein the processor is to compare the calculated linearization curve with a plurality of predefined linearization curves and select a closest linearization curve from the predefined linearization curves based on the comparison; and
wherein the printer is to print on the print media using a calibration associated with the closest linearization curve.

9. A printing apparatus according to claim 8 wherein the printing apparatus provides a media print path and the sensor is a spectrophotometer located along the media print path to measure the printed linearization chart.

10. A printing apparatus according to claim 8 wherein the processor is to compare the calculated linearization curve with each of the predefined linearization curves by calculating an RMS difference between the calculated curve and each predefined curve.

11. A printing apparatus according to claim 8 wherein
the printer is to print using a set of process color print agents and the linearization chart comprises a linearization plot for each process color print agent; and
the processor is to calculate a linearization curve for each process color print agent and compare each of the calculated linearization curves with a plurality of predefined linearization curves, and wherein the comparison comprises determining an average RMS difference for the set of process color print agents.

12. A printing apparatus according to claim 8 wherein the processor is further to receive an input selecting a print media type having particular mechanical properties and to apply settings within the printer based on the mechanical properties of the selected print media type.

13. A tangible machine-readable medium comprising a set of instructions which, when executed by a processor, cause the processor to:
receive a measured linearization response from a print media for each of a set of process colors;
compare the measured linearization response to each of a plurality of predefined linearization functions by calculating a root mean square difference between each measured linearization response and each predefined linearization function;
determine a closest linearization function as being a set of predefined linearization functions having a lowest root mean square difference averaged over the set of process colors; and
apply a linearization calibration based on the closest linearization function to an image to be printed on the print media.

14. A tangible machine readable medium according to 13, wherein the measured linearization response comprises a measured photometric response as a function of number of drops applied to the print media per halftone cell.

15. A tangible machine-readable medium according to claim 13, further comprising instructions to associate the applied linearization calibration with the print media and store the applied linearization for application to print media of the same type during subsequent printing operations.
